(19) United States
(12) Patent Application Publication
(10) Pub. No.: US 2007/0235480 A1
(43) Pub. Date: Oct. 11, 2007

(54) Kiddie Cover

(76) Inventors: Jill Russo, (US); Mark C. Bartone, (US)

Correspondence Address: JILL RUSSO, 43 SOUTH ELM STREET, WALLINGFORD, CT, 06492, US

(21) Appl. No.: 11/374,523

(22) Filed: Mar. 13, 2006

(51) Int. Cl. A61G 1/00

(52) U.S. Cl. 224/160; 150/154

(57) ABSTRACT

A Kiddie Cover is fabricated from a material which provides resistance to rain and/or cold. It is in the form of a closed structure which conforms to the shape of a child positioned in a carrier. The Kiddie Cover is placed over the top of a child seated in a baby carrier. The cover has a hole in the bottom. There is an opening which allows exposure of the infant's face. Once the Kiddie Cover is placed over a baby in it's carrier, the straps from the carrier are pulled through the two openings located on the front of the Kiddie Cover below the opening for the infant's face.

### BACKGROUND OF THE INVENTION

The present invention relates generally to the protection of a child in it's carrier from harsh weather, more particularly, the invention consists of a protective covering structure intended to surround and seal the baby in its carrier from inclement weather.

There are various systems which allow an adult to carry an infant while allowing the adult's hands to remain free. In general, most baby carriers position an infant against an adult's chest or back. Such carriers consist of several straps connected to a frame which support a seat for a child. The child is placed upright in the seat. The carrier itself is then usually supported by several additional straps which are placed over the shoulders of an adult to support the carrier against the adult's body. Some carriers also contain a stand on the base of the carrier allowing it to be supported in a stable, upright position when placed on the ground.

Such carriers do not normally protect the infant against ambient weather conditions. There have been however, carriers with removable sun shades as shown in U.S. Pat. No. 5,609,279 issued on Mar. 11, 1997 to Timothy O'Shea and U.S. Pat. No. 5,848,741 issued on Dec. 15, 1998 to Paul F. Fair. Such devices only provide a cover above the infant's head. They do not otherwise provide protection from inclement weather.

Some attempts have been made to protect an infant in a carrier from cold and rain. For example, in U.S. Pat. No. Des. 132,469 issued on May 19, 1942 to Murphy, a Knapsack Bunting is disclosed. In such an arrangement, a baby covering or bunting is permanently attached to and forms part of the carrier. Similar devices are shown in U.S. Pat. No. 4,923,104 issued on May 8, 1990 to Doris Rice and Kevin A. Rice and U.S. Pat. No. 5,772,088 issued on Jun. 30, 1998 to Elizabeth Nelson. While such systems may protect against inclement weather, when entering a protected environment the child would be too heavily insulated and accordingly, overheated. The only option with such a system is to remove the child from the carrier.

U.S. Pat. No. 4,333,591 issued on Jun. 8, 1982 to Dorothy S. Case does disclose a carrier cover and a separate weather protective hood for a baby and baby carrier. The cover is in the form of a sack with an opening at the top. A structure of this nature does not provide for the maximum protection of a child in inclement weather since it leaves an opening around the baby's neck allowing rain water to enter the baby backpack sack. This structure also presents problems in removing the protective covering with a child in the carrier. Since the baby backpack sack is placed over the bottom of the baby carrier and the carrier straps slide through a small opening, the carrying straps must be unfastened and as a practical matter, the child must be removed from the carrier in order to remove the protective covering.

Although various baby carriers have been made, none of the devices have addressed this issue of providing adequate protection which is easily removable from the child in his carrier when the child is transferred to an indoor or warmer environment.

### BRIEF SUMMARY OF THE INVENTION

The present invention is a Kiddie Cover which protects and covers a baby in it's carrier from inclement weather. The Kiddie Cover is fabricated from a material which provides resistance to rain and heat insulation. It is in the form of a closed tubular shaped structure made of a soft material. The upper end of the Kiddie Cover has a smaller tubular shaped enclosure with an opening on the front of it for the child's face to form a hood over the child's head. The main body of the present invention has two long vertical openings. Both openings are located on the front of the Kiddie Cover below the upper opening. Such openings are located in a position where the straps of a baby carrier can be easily placed through the openings. The Kiddie Cover has it's primary opening located at the base of the structure.

The Kiddie Cover is placed over the top of a child seated in a baby carrier. The hood of the Kiddie Cover is placed over the infant's head allowing the infant's face to be seen through the upper opening. Once the Kiddie Cover is placed over a baby in it's carrier, the straps from the carrier are pulled through the two openings located on the front of the Kiddie Cover below the opening for the infant's face. The straps from the baby carrier are then available for use in placing the baby carrier on an adult.

The hood opening has an elastic band around it which allows the hood to fit snugly around the infant's face. Such placement of the elastic reduces the exposure of the infant's body to the inclement weather and allows the interior to be fully protected. The primary opening located at the bottom of the structure also has an elastic band around it. The placement of this elastic band allows the lower portion of the infant and carrier cover to fit snugly around the base of the carrier and the infant's lower body. This snug fit allows more heat to be retained in the interior of the Kiddie Cover. Such placement of the larger opening at the bottom of the structure allows the cover to be placed over the top of the child in it's carrier. This structure also allows for easy removal of the Kiddie Cover while the infant remains seated in it's carrier.

### BRIEF DESCRIPTION OF THE DRAWINGS

FIG. 1. is a view of a conventional baby carrier.

FIG. 2. is a side view of the Kiddie Cover placed over a baby sitting in a baby carrier which is carried by an adult.

FIG. 3. is a front view of the Kiddie Cover which demonstrates the opening on top for a child's head and two openings along the front for a baby carrier's straps to fit through.

FIG. 4. is a rear view of the Kiddie Cover.

FIG. 5. is a front view of the Kiddie Cover which demonstrates the positioning of a baby carrier's straps placed through the openings of the Kiddie Cover.

FIG. 6. is a front view of the infant and carrier cover which demonstrates the Kiddie Cover placed over a baby carrier containing an infant.

### DETAILED DESCRIPTION OF THE PREFERRED EMBODIMENT

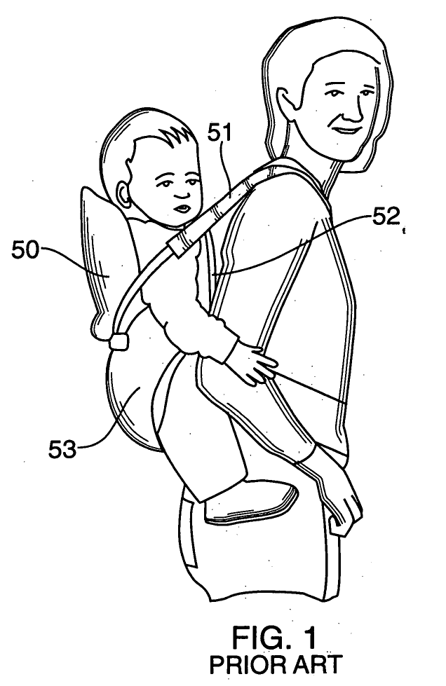

Turning now to the drawings, FIG. 1 shows a typical baby carrier 50 for holding a child. It consists of several straps 51 connected to a structure 52 which holds a seat 53 where a child may sit upright. The seat 53 may be connected to the structure 52 using several different methods so long as the connection is sturdy enough to support a child capable of being placed in the baby carrier 50. The straps 51 are arranged in a manner where as to allow an adult to place his or her arms through the straps 51 after a child has been placed in the baby carrier 50. The straps 51 are normally adjusted to a position where as to allow the child to be close to the adult. This positioning allows both the child and adult to feel secure in carrying of the child.

As can be seen from FIG. 1, such an arrangement leaves the child in the carrier exposed to the ambient weather. Thus, in use, the child can be exposed to freezing temperatures or soaked by rain. Of course, the child may be dressed in a protective garment such as a snow suit or rain gear. However, when the person carrying the child enters a structure, in order to prevent overheating, the child must be removed from the carrier 50, the snow suit or other protective clothing removed and then the child placed back into the carrier 50.

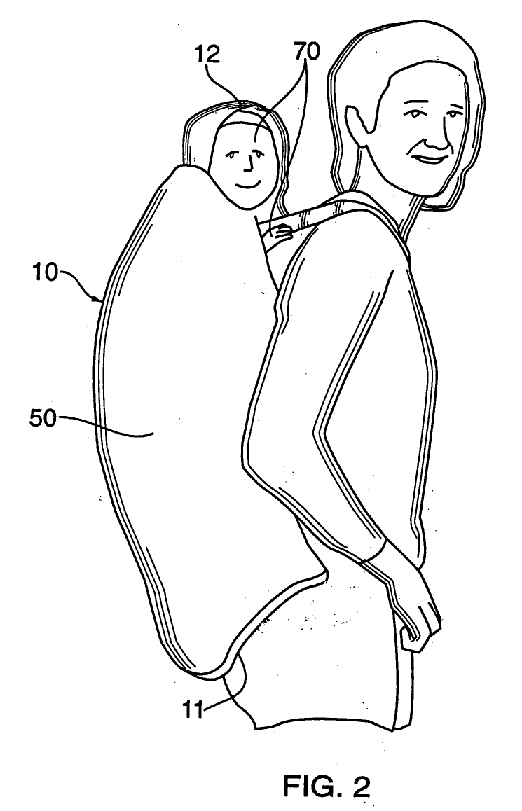

FIG. 2 shows a child 70 in a protective Kiddie Cover 10 in accordance with the present invention. The Kiddie Cover 10 is made from a material which is either or both water resistant and has heat insulating properties. The cover 10 fits over the baby 70 and the baby carrier 50. As can be seen in FIG. 2, there is an opening 12 to allow an infant's face to be exposed to the environment. There is a second opening 11, at the bottom of the Kiddie Cover 10 to be placed over the carrier 50. Both openings 11 and 12 have elastic bands 15 and 18, respectively. Band 18 holds a portion of the cape forming a hood 16 around the child's face. Elastic band 15 pulls the bottom of the Kiddie Cover 10 snugly around the bottom of the carrier and the child's feet.

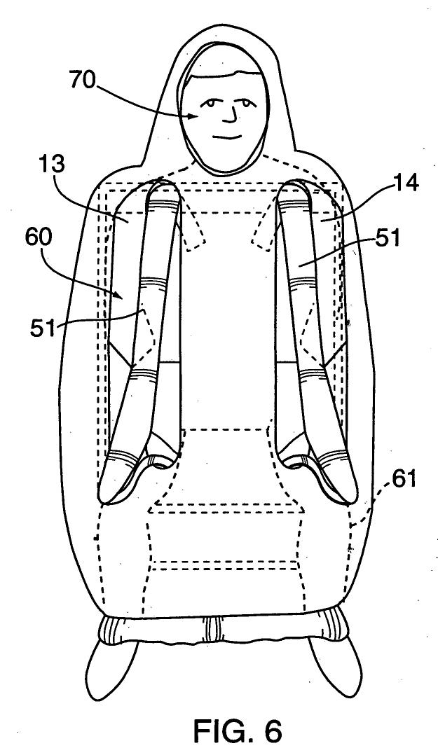

FIG. 6 shows the child 70 seated in the carrier 50. As one can see, arms 60 and legs 61 are within the cover 10.

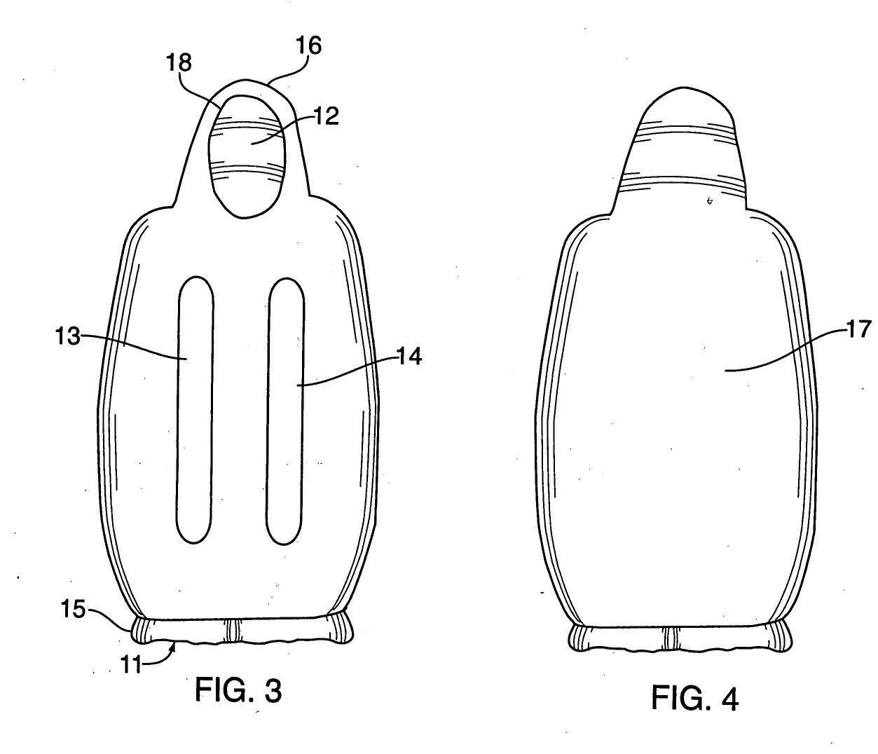

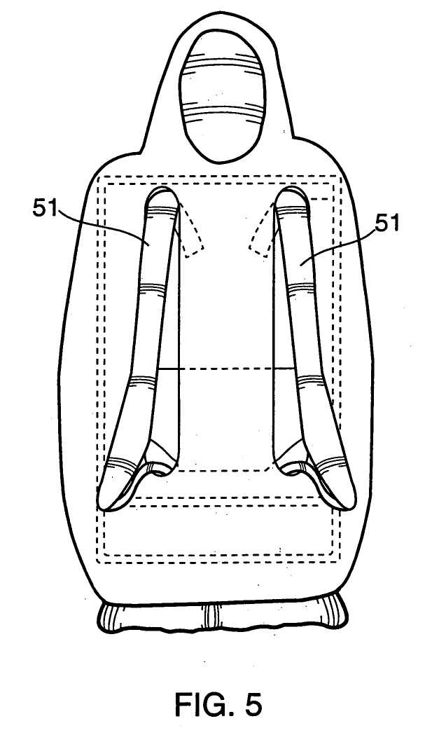

As seen most clearly in FIGS. 3 and 4, the cover 10 is shaped to have a narrower hood portion and a wider body portion 17 conforming both to the contours of the child 70 and the baby carrier 50. Elongated openings 13 and 14 are positioned between the face opening 12 and the bottom opening 11. The straps 51 of the carrier fit through these openings 13 and 14. As seen in FIG. 5, this positions and holds the cover 10 around the carrier 50.

Also as seen in FIGS. 2 and 6, the extended openings 13 and 14 are sufficiently wide to let the child 70 extend his or her hand through the opening to either grip the straps 51 or the adult or to withdraw them within the cover 10.

In use, the child 70 is placed within the carrier 50 and when the carrier is resting on a surface. The cover 10 is then placed over the carrier 50 and child 70 and the straps 51 are pulled through openings 13 and 14. Then the person carrying the child 70 lifts the carrier 50 and child 70 and slips his or her arms through the straps 51. The cover 10 is then pulled down to cover the bottom of the carrier 50 as well as the child's feet and legs. Equally, to remove the cover 10, the carrier 50 is then placed on a flat surface and the cover 10 removed leaving the child 70 in the carrier 50 during the operation. The person carrying the child 70 can then again slip their arms through the straps 51.

While the invention has been described as having a preferred design, it is understood that it is capable of further modification, uses and/or adaptations of the invention. It will be obvious to those skilled in the art to make various changes, alterations and modifications to the invention described herein. To the extent that these variations, modifications and alterations depart from the scope and spirit of the appended claims, they are intended to be encompassed therein.

I claim:

1. A Kiddie Cover for covering and protecting a child contained in a baby carrier having shoulder straps, comprising:
a main elongated body section of the cover having an opening at its lower end for covering an infant carrier and the torso of an infant;
a smaller section of the cover forming a hood having an opening for the infants head; and
two elongated slots in the elongated body section of the cover shaped to allow the straps of the carrier to be positioned through the cover.

2. A Kiddie Cover according to claim 1, wherein the cover section is shaped to conform to the contours of the body of the child and the carrier.

3. A Kiddie Cover according to claim 2, wherein there is elastic around the opening for the infant's head in the smaller section of the cover.

4. A Kiddie Cover according to claim 2, wherein there is elastic around the opening on the lower end of the main body of the cover.
